(19) United States
(12) Patent Application Publication
(10) Pub. No.: US 2002/0068580 A1
(43) Pub. Date: Jun. 6, 2002

(54) METHOD AND WIRELESS COMMUNICATION SYSTEM FOR POLLING TO OBTAIN INFORMATION FOR SUBSCRIBERS

(76) Inventors: SRINIVAS BALA, DAYTON, NJ (US); MICHAEL COMSTOCK, FREEHOLD, NJ (US); PETER KAPSALES, HOLMDEL, NJ (US); RALPH J. SNYDER, BARNEGAT, NJ (US)

Correspondence Address: S H DWORETSKY, AT & T CORPORATION, P O BOX 4110, MIDDLETOWN, NJ, 07748

(21) Appl. No.: 09/208,431

(22) Filed: Dec. 10, 1998

(51) Int. Cl. H04Q 7/20

(52) U.S. Cl. 455/456; 455/445

(57) ABSTRACT

A wireless communication system and method poll subscribers based on a movement history for the subscribers. Movement information for subscribers is stored and analyzed to determine the likely current location(s) for a subscriber. Polling is performed based on a result of analyzing the movement information. For example, polling the subscriber can be performed using transmitters in a serial manner, such that a first transmitter, or group of transmitters, that corresponds to the most likely current location of the subscriber is used to poll the subscriber. If polling using the first transmitter is not successful, a second transmitter, or group of transmitters, corresponding to a second most likely location of the subscriber is used to poll the subscriber, and so on.

### BACKGROUND OF THE INVENTION

1. Field of Invention

This invention relates to polling wireless service subscribers to determine a subscriber's current location.

2. Description of Related Art

Wireless communication systems, e.g., systems that provide voice and/or data transmission services, poll their subscribers to determine if they are an authorized subscriber in good standing and to identify the transmitter nearest the subscriber's current location. Knowing subscriber location information allows the service provider to maximize system capacity because a transmitter, or group of transmitters, nearest each subscriber's current location can be used to communicate with the subscriber. Without knowing a subscriber's current location, a group of transmitters that cover a relatively large geographic area in which the subscriber may be located would have to be used to communicate with the subscriber.

When transmitters in the communication system each cover a relatively large geographic area and there are relatively few transmitters in the system, all of the transmitters can be used, e.g., simultaneously, to poll a desired subscriber and determine the location of the subscriber. However, as the number of transmitters in the system increases and the geographic area covered by each transmitter decreases, a significant portion of the capacity of the communication system must be used to perform polling functions. In some cases, communication by subscribers can be interrupted, slowed or otherwise affected by an overload of system capacity due to polling operations.

### SUMMARY OF THE INVENTION

The invention provides a communication system and method for polling subscribers such that system capacity is efficiently used. A subscriber's current location is anticipated based on movement information for the subscriber, and polling is performed based on the subscriber's anticipated current location. Anticipated locations for a subscriber can be determined from a statistical or other analysis of the subscriber's movement information. Movement information for a subscriber can include past locations for a subscriber, e.g., the identity of and number of times transmitters have successfully polled the subscriber, or future expected movement activity.

Polling of the subscriber can be done by using transmitters serially in a manner according to the subscriber's most likely current location, such that a transmitter, or group of transmitters, corresponding to a first most likely current location is first used to poll the subscriber. If a polling operation for the first transmitter is not successful, a transmitter, or group of transmitters, corresponding to a second most likely current location is used to poll the subscriber, and so on. However, other polling methods based on the subscriber's movement information are possible.

A frequency for polling of subscribers can be adjusted based on movement information for the subscribers. For example, if the likelihood that a given subscriber is at a particular location is high, (i.e., exceeds a predetermined threshold), the subscriber may be polled less frequently than other subscribers whose current location can less certainly be anticipated.

Time information or other information can be considered as part of a subscriber's movement information. For example, a day or time of day can be considered in connection with a subscriber location as part of the subscriber's movement information.

### BRIEF DESCRIPTION OF THE DRAWINGS

The invention is described in detail with regard to the following figures wherein like numerals reference like elements, and wherein:

FIG. 1 is a flow chart of steps of a method for polling subscribers in accordance with the invention;

FIG. 2 is a schematic block diagram of a communication system in accordance with the invention;

FIG. 3 shows a first group of transmitters in an area and corresponding sub-areas covered by the transmitters; and

FIG. 4 shows a second group of transmitters in an area and corresponding sub-areas covered by the transmitters.

### DETAILED DESCRIPTION OF PREFERRED EMBODIMENTS

As described above, the invention is directed to polling subscribers of a wireless communication system in such a way that communications resources of the system are efficiently used. As used herein, the term subscriber refers to the actual device that is used by a person or other entity for communications purposes and the person or entity using communications services of the communication system. The term subscriber unit is used where the actual device that is used for communication purposes is referred to rather than the person or entity using the device. The term subscribing individual is used to refer to the person or entity using the communications services of the communication system.

As will be understood, subscribers in a wireless communication system can freely move from one location to another. In fact, this is one of the attractive features of wireless communication. Thus, wireless communication systems typically have transmitters spatially distributed over a geographic area so that subscribers moving within the distributed area can communicate with the system. However, it is preferable for the system to know the location of subscribers so that if a communication is to be directed to a subscriber, the system can send the communication to the subscriber using an appropriate transmitter, e.g., the transmitter closest to the subscriber. Polling is the procedure typically used to identify the location of subscribers in the system.

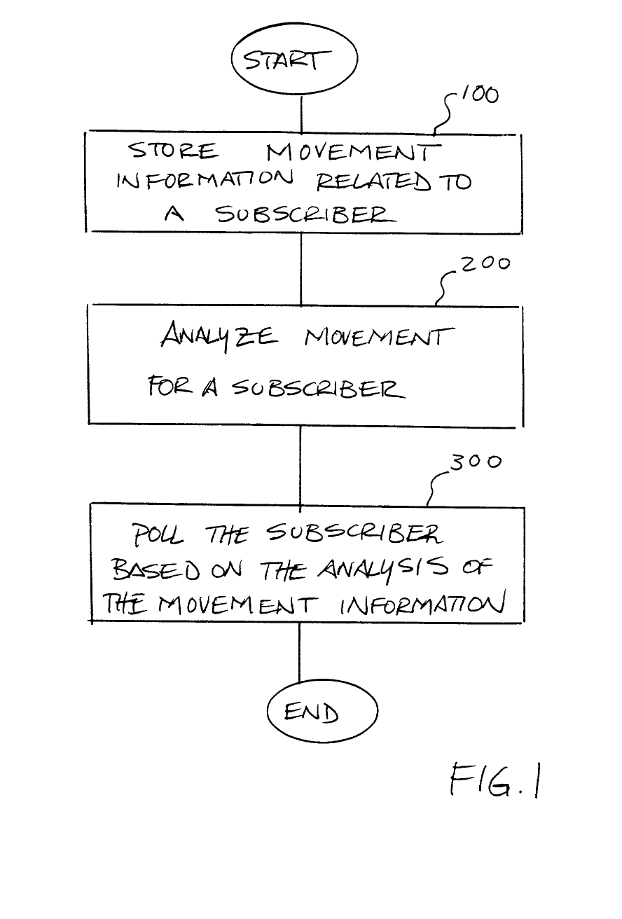

FIG. 1 is a flowchart of steps for a method for polling subscribers. In step 100, movement information for a subscriber is stored. In general, the movement information describes the past movement information of a subscriber based on previous locations of the subscriber determined in past polling operations, and/or describes the expected future movement of the subscriber. For example, every time a communication system polls a subscriber and determines the location of the subscriber, the communication system could store the determined location as part of the subscriber's movement information. The subscriber's location can be a precise location, such a geographical coordinate determined by a global positioning device (GPS device), or the location, coverage area, or identity of the transmitter(s) that successfully polled the subscriber. The location information can be stored in many different ways, including a list of locations that the subscriber has been polled at, and/or a number of times each transmitter has successfully polled a subscriber.

Alternatively, information regarding past movement and/or expected future movement for a subscriber could be provided and stored, rather than sensed. For example, a subscribing individual could provide information about his past movement history, which is stored as part of the subscriber's movement information, such as “I have been and/or will be in City X every first Tuesday of the month.” Other information can be stored as part of the movement information, such as registration information, the direction and speed of movement of the subscriber (for anticipating the subscriber's future location), the identity of the transmitter that successfully polled the subscriber, authorization information, and/or the time, day, month, year, etc. that a subscriber was polled along with the subscriber's location.

In step 200, when the communication system determines it is time to poll the subscriber, the movement information for the subscriber is analyzed to determine the likely current location of the subscriber. Preferably, a hierarchical list of probable current locations is determined where a first location (e.g., transmitter) in the list is the most likely current location for the subscriber, followed by a second location (e.g., transmitter) that is the second most likely current location, and so on. However, only one most probable location can be determined, if desired. The probable location(s) of the subscriber need not be exact physical locations of the subscriber, but can be an expected area within which the subscriber is located, or a transmitter, or group of transmitters, that can be used to poll the subscriber.

For example, if a subscriber should be polled at 3PM on a Thursday, the movement information for the subscriber is analyzed to determine the probable current location or locations of the subscriber. In this example, it may be determined that the subscriber was successfully polled eight times by transmitter X, five times by transmitter Y, and two times by transmitter Z during some previous time period, e.g., the last month. The analysis can be done using all of the stored movement information for the subscriber, or only selected portions can be used. In this example, movement information only relevant to polling at 3PM on a Thursday could be used, e.g., movement information indicating subscriber location on weekday afternoons or on Thursday afternoons. In contrast, probable subscriber current locations could be determined based on all or substantially all of the movement information for the subscriber. The likely location(s) of a subscriber can also be determined based on information in addition to the subscriber's past location(s). For example, a subscriber's likely current location could be determined, at least in part, based on the subscriber's last location, the speed and direction of travel of the subscriber and the time when the subscriber's last location was confirmed. This information can be used to estimate the subscriber's current position, e.g., if the subscriber was traveling in an airplane.

In step 300, the subscriber is polled based on the analysis of the subscriber's movement information. Preferably, transmitters, or groups of transmitters, are used serially to poll the subscriber in accordance with the location(s) determined in step 200. For example, a transmitter X, or group of transmitters, corresponding to a first most probable location is used to poll the subscriber. If this polling operation is not successful, a second transmitter Y, or group of transmitters, is used to poll the subscriber, and so on. If the subscriber is not located in any of the probable locations determined in step 200, a default polling procedure can be followed to locate the subscriber, such as using transmitters not yet used to poll the subscriber simultaneously, serially, in groups, or in some other manner to poll the subscriber. The transmitters, or groups of transmitters, corresponding to the probable locations of a subscriber need not be used serially to poll a subscriber, however. Instead, the transmitters could be used in some other fashion, e.g., simultaneously, in groups, or in some other manner, to poll the subscriber, although methods other than serial polling may not make the most efficient use of communication resources. When a subscriber is successfully polled, location information and optionally other information, e.g., time and date, are stored as part of the movement information for the subscriber.

Other features of polling a subscriber can be controlled based on an analysis of the subscriber's movement information, such as the frequency for polling the subscriber. For example, if the probability that a subscriber is located at a most likely location exceeds a predetermined threshold, a decision could be made not to poll the subscriber or to decrease the frequency of polling the subscriber. Conversely, if the probability that the subscriber is at any location does not exceed a threshold, a decision could be made to poll the subscriber more frequently. In addition, polling frequencies could be adjusted for different periods, e.g., different times of day. For example, a subscriber may be polled less frequently at night as compared to during the day, depending on the relevant movement information for the subscriber.

The invention is particularly useful when transmitters in a communication system cover very small areas, or microcells. For example, a microcell may only cover a single floor, or a portion of a single floor, in a building. Thus, conventional polling methods can be frustrated since a subscriber can easily move in and out of a microcell. The result is that in conventional polling methods, groups of transmitters must be used to poll a subscriber, potentially crippling system capacity. In contrast, the invention anticipates subscriber movement and polls subscribers using minimal system resources.

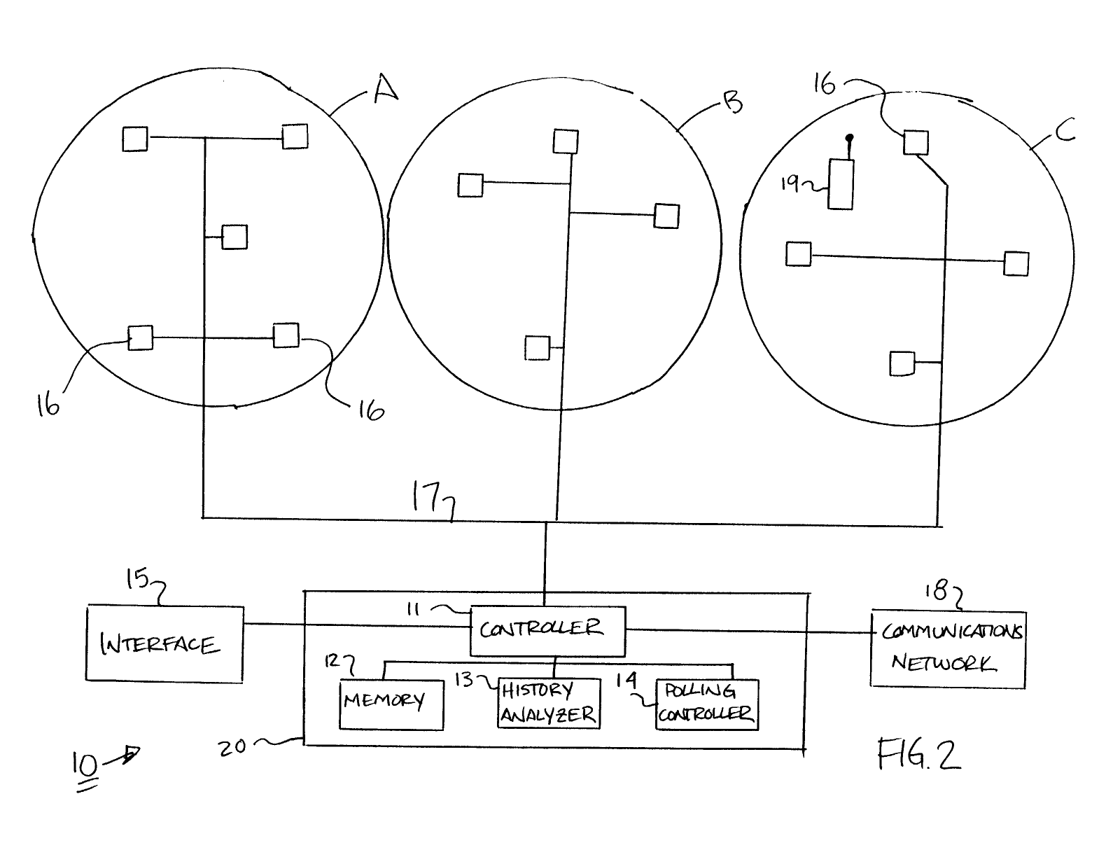

FIG. 2 shows a communication system 10 in accordance with the invention. The communication system 10 includes a data processing system 20, which can be a general purpose computer, or network of general purpose computers, and other associated devices, including communications devices, modems, relays, motors, mechanical linkages, and/or other circuitry or components necessary to perform the desired input/output or other functions.

The data processing system 20 includes at least one controller 11 that can be implemented, at least in part, as a single special purpose integrated circuit (e.g., ASIC) or an array of ASICs, each having a main or central processor section for overall, system-level control, and separate sections dedicated to performing various different specific computations, functions and other processes under the control of the central processor section. The controller 11 can also be implemented using a plurality of separate dedicated programmable integrated or other electronic circuits or devices, e.g., hardwired electronic or logic circuits such as discrete element circuits or programmable logic devices. The controller 11 also preferably includes other devices, such as volatile or non-volatile memory devices, communications devices, relays, and/or other circuitry or components necessary to perform the desired input/output or other functions.

The data processing system 20 also includes a memory 12, which can be one or more volatile and/or non-volatile memory devices, such as optical disk, magnetic media, semiconductor or other memory devices.

A history analyzer 13 and polling controller 14 are also included for analyzing stored movement information relating to subscriber movement and controlling polling operations, respectively. The history analyzer 13 and the polling controller 14 can be implemented as software modules that are executed by the controller 11 or any other suitable data processing apparatus. Alternately, the history analyzer 13 and the polling controller 14 can be implemented as hard-wired electronic circuits or other programmed integrated or other electronic circuits or devices, e.g., hardwired electronic or logic circuits such as discrete element circuits or programmable logic devices.

An interface 15 allows users to interact with the communication system 10 and can include one or more of a keyboard, mouse or other user pointing device, touch screen and associated display, a display, a voice recognition system, a scanner, data input/output device or any other device that allows a user to input information into and/or receive information from the communication system 10. The interface 15 can also include security devices that control access to the communication system 10.

The data processing system 20 communicates with spatially distributed transmitters 16 by communication lines 17. The communication lines 17 can be hardwired or wireless connections to the transmitters 16, or a combination of wired and wireless connections. Thus, the data processing system 20 can send control information or other information, such as voice or data communications, to the transmitters 16 and receive information from the transmitters 16. The transmitters 16 are constructed as is well known in the art, and include at least a wireless signal transceiver and associated control circuitry.

The communication system 10 can also include a communications network 18, such as a public telephone network, a computer network (e.g., a LAN or WAN), the internet, or other network or group of networks. The communications network 18 can provide and/or receive subscriber information and/or communications information, e.g., voice or data transmissions. Thus, subscribers using the communication system 10 can receive and/or send communications information to other subscribers within the communications system 10 or to other people or systems through the communications network 18.

The communication system 10 transmits information to and receives information from subscribers 19 through one or more of the transmitters 16. The subscriber units 19 can be cellular telephones, paging devices or any other wireless communications device. Since the subscriber units are wireless communication devices, the subscriber units can be transported to different locations within, or outside of, a geographic area covered by transmitters 16 in the communication system 10. Likewise, subscribing individuals using different subscriber units can move to different locations within, or outside of, the geographic area covered by the transmitters 16. Thus, the communication system 10 keeps track of the current location of subscribers 19 to make the most efficient use of communication resources.

To keep track of the current location of subscribers 19 and obtain other registration information, the communication system 10 polls the subscribers 19 periodically. Polling includes transmitting a signal from at least one transmitter 16 that is directed to a particular subscriber 19. When the appropriate subscriber unit 19 receives the signal, the subscriber unit 19 processes the signal, determines that the signal is directed to it, and transmits a confirmation signal to confirm its (or an associated subscribing individual's) location and/or other information. If the communication system 10 is determining the location of a subscribing individual, rather than a subscriber unit, the subscribing individual can enter information into a subscriber unit indicating that the particular subscribing individual is currently using the subscriber unit.

Keeping track of subscribing individuals in addition to the subscribing units can be useful in situations where subscribing individuals use several different subscribing units during the course of a day, week, month, etc. and the communication system 10 routes telephone calls or other information directly to the subscribing individual. Thus, a subscribing individual could use different subscribing units, but always receive telephone calls, for example, on whatever subscribing unit the individual currently is currently using. Keeping track of individual subscribing units can be useful where the unit is always used by the same subscribing individual, or where different subscribing individuals use the subscribing unit, but the subscribing unit moves between a same set of locations, e.g., where the subscribing unit is a mobile phone fixed in a delivery truck that always travels the same delivery route independent of the operator of the vehicle.

A transmitter 16 receives the confirmation signal and notifies the controller 11 that the location of the subscriber 19 has been confirmed. The location of the subscriber 19 can be contained in the confirmation signal sent from the subscriber unit 19, e.g., the subscriber unit 19 could include a positioning device, such as a global positioning device (GPS device), and send the precise location of the subscriber unit 19 to the transmitter 16. The subscriber unit 19 could also provide information regarding the direction and speed of movement of the subscriber unit 19 so that the communication system 10 can anticipate the location of the subscriber unit 19 at some future time. Alternately, the location of the subscriber 19 could be determined by the location of the transmitter 16, or transmitters 16, receiving the confirmation signal from the subscriber unit 19.

When the controller 11 receives confirmation that the location of a subscriber 19 has been confirmed, the location information is stored as part of movement information for the subscriber 19 in the memory 12. Optionally, information in addition to the location of the subscriber unit 19 can be stored, such as the time, day, month, etc. when the location of the subscriber 19 was confirmed. However, this additional information is not required. Subscriber movement information can also be input into the communication system 10 through the interface 15 and stored in the memory 12, if desired. That is, subscribing individuals can be asked to complete a movement information questionnaire at the time of initial registration, or periodically, if desired. The questionnaire could ask the subscribing individual to indicate the likely locations for a subscriber 19 in general, for a given day of the week, time of day, etc. This information could be entered manually using a keyboard of the interface 15, or loaded into the communication system 10 from a storage device, such as a floppy disk. Thus, the information could provide initial movement information for a subscriber 19 and be updated over time.

As discussed above, the communication system 10 polls subscribers 19 periodically at some predetermined time interval. When the polling controller 14 determines that it is time to poll a specific subscriber 19, the history analyzer 13 accesses stored movement information in the memory 12, and analyzes the information to determine a set of locations that the subscriber 19 may be currently located in. The analysis of the history analyzer 13 is preferably a statistical analysis that provides the probability that the subscriber 19 is located in a given location or locations. For example, the movement information for a subscriber could include a list of all of the transmitters, or groups of transmitters, that have successfully polled the subscriber along with a corresponding bucket. The bucket corresponding to each transmitter stores a number of times that the corresponding transmitter has successfully polled the subscriber. In this example, the history analyzer 13 determines the transmitter that has most often successfully polled the subscriber, followed by the next transmitter that has second most often successfully polled the subscriber, and so on. Alternately, the history analyzer 13 could determine a percentage chance that the subscriber is located in proximity to each transmitter, e.g., a ratio of the number of successful polls in the transmitter's bucket divided by the total number of successful polls for the subscriber. The history analyzer 13 can also include time stamp information corresponding to successful polling information for each transmitter in its analysis. For example, the history analyzer 13 could only use the number of successful polls in a transmitter's bucket that meet a desired time stamp criterion, e.g., occurred after a particular date, within a particular period of the day, etc.

The history analyzer 13 could perform other analysis of the movement information, such as identifying a location identified for a subscriber in a past movement information questionnaire. Preferably, the history analyzer 13 generates a list of most probable locations for a subscriber and corresponding probabilities that the subscriber is currently located in each location in the list.

Using the probabilities and/or the locations determined by the history analyzer 13, the polling controller 14 determines a set of transmitters 16 for polling the subscriber 19 and the order in which the transmitters 16 should poll. For example, the polling controller 14 could determine that a first transmitter 16 associated with an area for which there is a highest probability that the subscriber 19 is located in the area should be first used to poll the subscriber 19. If the first transmitter 16 does not locate the subscriber 19, a second transmitter 16 associated with an area for which there is a second highest probability that the subscriber 19 is located in the area should next be used to poll the subscriber 19. If the second transmitter 16 does not locate the subscriber 19, a third transmitter 16 is used, and so on. Therefore, only communication resources that are most likely to locate the subscriber 19 are used in a serial manner so that the communications resources of the communication system 10 can be efficiently used. Once the location of a subscriber 19 has been located, the location information, and any other information, such as the time and date of the successful polling operation, is stored in the memory 12 for later analysis in conjunction with other polling operations.

As discussed above, the history analyzer 13 could use information in addition to the locations at which a subscriber 19 has been located in the past to determine the likely current location of a subscriber 19. For example, the history analyzer 13 could use the time of day, day, week, month, year, etc. in conjunction with corresponding movement information to determine the likely current location of a subscriber 19. For example, if the polling controller 14 determines that a subscriber 19 should be polled at 3PM on a Wednesday, the history analyzer 13 could retrieve and analyze movement information for the subscriber 19 relevant to polling at 3PM on Wednesday, e.g., movement information for past Wednesday afternoons. Thus, while for any other day of the week the subscriber 19 may have a 90% chance of being at location A, on Wednesday afternoons there may be a 90% chance that the subscriber is at location B. Thus, polling could begin with a transmitter 16, or transmitters 16, associated with location B. Other information can also be used to analyze the probable location of a subscriber 19, such as information for a particular occurrence, e.g., the first Monday of the month or April 15, or condition, e.g., if the subscriber 19 was last located at location A, the probability that the subscriber 19 is now at location B may be higher than normal.

As also discussed above, the polling controller 14 can control a frequency for polling a subscriber 19 based on movement information for the subscriber 19. For example, if the probability that the subscriber 19 is at a particular location exceeds a predetermined threshold, the polling controller 14 could reduce the frequency of polling the subscriber 19, or determine that the subscriber 19 should not be polled. Likewise, if the probability that a subscriber 19 is at a particular location is less than a predetermined level, the polling controller 14 may increase the polling frequency for the subscriber 19.

As shown in FIG. 2, the transmitters 16 can be located in a spatially distributed fashion to cover a wide area. FIG. 2 shows only three areas A, B and C that are covered by the transmitters 16, but the transmitters 16 can be distributed to cover fewer or more than three distinct areas. Moreover, the areas A, B and C covered by the transmitters 16 need not be separated, but can be immediately adjacent to or overlap each other. The areas A, B and C can be wide geographic areas, such as an entire city or state, or smaller areas, such as a single floor in a building. Further, the distribution of transmitters 16 in the areas A, B, and C shown in FIG. 2 is only an example of the possible distributions of the transmitters 16. Of course, more or fewer transmitters 16 could be used for each area A, B and C.

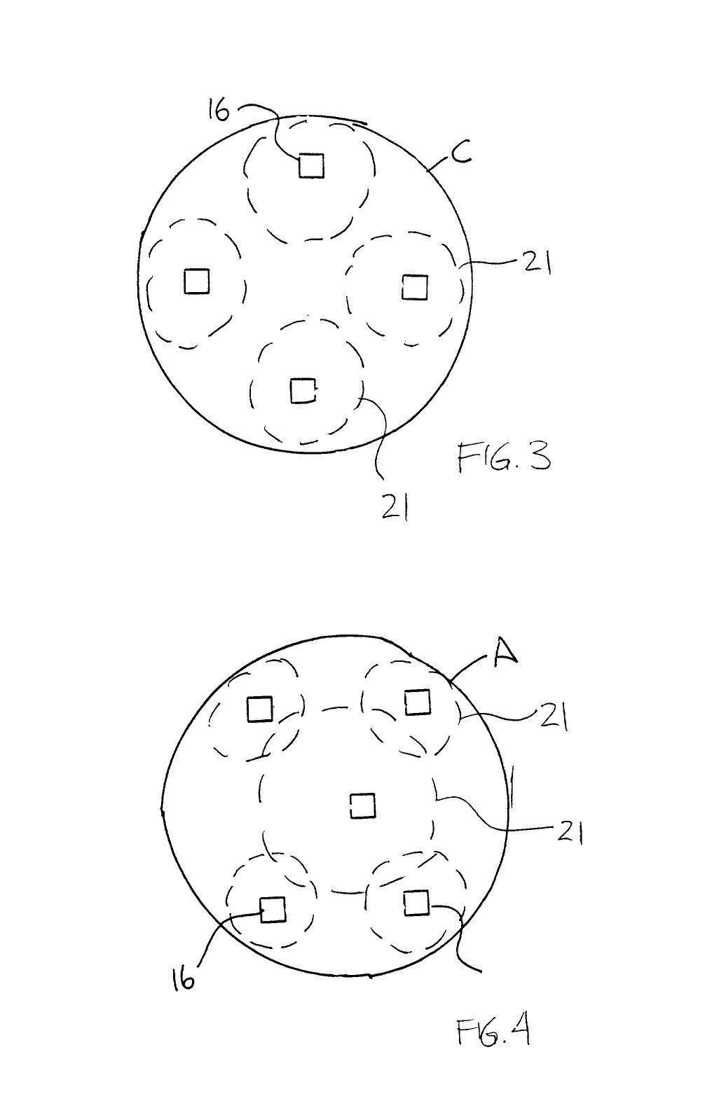

FIG. 3 shows the area C and example coverage areas 21 corresponding to each transmitter 16. In this example, the coverage areas 21 for each transmitter 16 do not overlap, and in fact, portions within the area C are not covered by the transmitter coverage areas 21. The portions not covered may be areas in which a subscriber 19 cannot move into, or areas where communications services are not available. FIG. 4 shows the area A and example coverage areas 21 for the transmitters 16. In this example, the coverage areas 21 partially overlap so that a subscriber 19 positioned within an overlap area could be successfully polled by at least two different transmitters 16. The communication system 10 can take advantage of overlapping coverage areas 21 when determining which transmitter(s) 16 to use to poll a subscriber 19. For example, if there is a high probability that a subscriber 19 is located within area A, but a low probability that the subscriber 19 is located within any one of the coverage areas 21 within the area A, the polling controller 14 may determine that polling should start with the central transmitter 16, which covers the largest area and overlaps several of the coverage areas 21 of other transmitters 16. On the other hand, if there is a high probability that a subscriber 19 is located within a specific coverage area 21 of another transmitter 16 in the area A, polling would normally start with that transmitter 16.

Although the invention has been described in connection with a particular communication system, the invention can be used with other systems, such as that described in U.S. Pat. No. 5,315,636 or any other system that can benefit from the advantages provided by the invention. For example, as will be appreciated by those of skill in the art, the invention can be used for personal communication services (voice), narrowband personal communication services (two-way messaging), and in-building office systems.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. A method for polling a subscriber in a wireless communication system, comprising:
storing movement information related to a subscriber;
analyzing the movement information for the subscriber; and
polling the subscriber based on a result of analyzing the movement information for the subscriber.

2. The method of claim 1, wherein the step of storing movement information comprises storing past location information for the subscriber.

3. The method of claim 1, wherein the step of storing movement information comprises storing information in addition to location information.

4. The method of claim 1, wherein the step of analyzing the movement information comprises determining the likelihood that the subscriber is currently located at at least one location based on the movement information for the subscriber.

5. The method of claim 1, wherein the step of analyzing the movement information comprises determining the probability that a subscriber is currently at each of a plurality of locations based on the movement information for the subscriber.

6. The method of claim 5, wherein the movement information includes location and time information.

7. The method of claim 1, wherein the step of analyzing the movement information comprises selecting portions of the movement information for analysis.

8. The method of claim 1, wherein the step of polling the subscriber comprises using transmitters in the communications system in a serial manner.

9. The method of claim 1, wherein the step of polling the subscriber comprises using a first at least one transmitter that corresponds to a first most likely location for the subscriber to poll the subscriber, and if a polling operation for the first at least one transmitter is unsuccessful, using a second at least one transmitter that corresponds to a second most likely location for the subscriber to poll the subscriber.

10. The method of claim 1, wherein the step of polling the subscriber comprises controlling a frequency of polling the subscriber based on the result of analysis.

11. A method for polling a subscriber in a wireless communication system, comprising:
storing location information related to past detected locations of a subscriber;
determining a set of probable current locations for a subscriber based on the location information; and
polling the subscriber using transmitters in the communication system in a serial manner, such that a first at least one transmitter corresponding to a first most likely location for the subscriber is first used to poll the subscriber, and if a polling operation of the first at least one transmitter is unsuccessful, a second at least one transmitter corresponding a second most likely location for the subscriber is next used to poll the subscriber.

12. A wireless communication system comprising:
a memory that stores movement information related to at least one subscriber;
a history analyzer that analyzes the movement information for a subscriber; and
a polling controller that polls the subscriber based on a result of analyzing the movement information for the subscriber.

13. The wireless communication system of claim 12, further comprising:
a plurality of transmitters that can communicate with the subscriber, each transmitter having a corresponding coverage area.

14. The wireless communication system of claim 13, wherein the coverage areas for at least two transmitters overlap at least partially.

15. The wireless communication system of claim 13, wherein the polling controller uses the plurality of transmitters in a serial manner based on the result of analysis of the movement information for the subscriber.

16. The wireless communication system of claim 13, wherein the history analyzer determines a set of most likely current subscriber locations; and
the polling controller uses the transmitters in a serial manner to poll the subscriber, such that a first at least one transmitter corresponding to a most likely current subscriber location is used to poll the subscriber, and if a polling operation for the first at least one transmitter is not successful, a second at least one transmitter corresponding to a second most likely current subscriber location is used to poll the subscriber.

17. The wireless communication system of claim 12, further comprising:
an interface that allows a user to input information into and receive information from the communications system.

18. The wireless communication system of claim 12, further comprising:
a communications network that provides information for and receives information from subscribers of the communication system.

19. The wireless communication system of claim 12, wherein the memory stores movement information for a plurality of subscribers.

20. The wireless communication system of claim 12, wherein the polling controller controls a frequency of polling for the subscriber based on the result of analysis.
